(19) United States
(12) Patent Application Publication
(10) Pub. No.: US 2024/0081954 A1
(43) Pub. Date: Mar. 14, 2024

(54) ORTHODONTIC DISTALIZER APPARATUS AND METHODS

(71) Applicant: Align Technology, Inc., San Jose, CA (US)

(72) Inventors: Siyi LIU, Dallas, TX (US); Yuxiang WANG, Newark, CA (US); Jun SATO, San Jose, CA (US); Jeremy RILEY, Mountain View, CA (US); James NISHIMUTA, Durham, NC (US)

(21) Appl. No.: 18/465,848

(22) Filed: Sep. 12, 2023

Related U.S. Application Data
(60) Provisional application No. 63/405,857, filed on Sep. 12, 2022.

(51) Int. Cl. A61C 7/08

(52) U.S. Cl. CPC A61C 7/08; A61C 13/34

(57) ABSTRACT

Apparatuses (e.g., distalizers) and methods for distalizing a subject's teeth while preventing or reducing undesirable tipping and/or rotation of the teeth. The distalizer apparatuses may include tooth engagement regions shaped to accommodate molars, canines and/or premolar teeth, may include a transpalatal region extending between engagement regions having an anterior edge that is posterior to a premolar region of the first tooth engagement region, and may include an attachment site for an elastic band on the outer buccal surface.

### CLAIM OF PRIORITY

This application claims priority to U.S. Provisional Patent Application No. 63/405,857, titled “ORTHODONTIC DISTALIZER APPARATUS AND METHODS” filed on Sep. 12, 2022, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Distalization is a process to treat Class II molar and canine malocclusion. During treatment, an appliance conventionally known as a distalizer is applied to the teeth to provide segmental distalization of the canine-to-molar posterior maxillary area or mandibular area. The distalizer may include a mesial element fixed to a canine or bicuspid, a distal element fixed to a molar, and an arm connecting the mesial element to the distal element. A ball member on the arm may be received in the distal element to allow the ball member to rotate and upright with respect to the molar. A hook for an elastomer, such as a band (e.g., rubber band) may be fixed to the mesial element and to the distal element. Over time, forces applied on the molar due to the connection between the mesial element and the distal element result in modifying the position of the teeth.

Conventional distalizers may result in undesirable tooth tipping and may be difficult to manufacture. What is needed are distalizers that may be easily manufactured and may avoid undesired tooth tipping in treatment. The methods and apparatuses described herein may address these needs.

### SUMMARY OF THE DISCLOSURE

Described herein are apparatuses (e.g., devices and systems, including distalizers and software or firmware for designing and fabricating them) and methods for distalizing a subject's teeth while preventing or reducing undesirable tipping and/or rotation of the subject's teeth. These methods and apparatuses may be part of an orthodontic treatment, and in particular, may be part of an orthodontic treatment including a series of orthodontic aligners, including “shell aligners” that may be removably worn over a subject's teeth (upper dental arch and/or lower dental arch). The apparatuses described herein may include a distalizer that is configured to be removably worn over the subject's maxillary (upper arch) teeth, in conjunction with a removably device (e.g., aligner) worn on the subject's mandibular (lower arch) teeth.

In general, these apparatuses and methods may include a transpalatal region, also referred to herein as a transpalatal arch or TPA, that can be integrated as part of the distalizer to limit the lingual tipping of the subject's molars and to reduce reaction forces to neighboring teeth. Optionally, the transpalatal region may enable concurrent arch expansion (or may retain arch expansion following a previous arch expansion step). The dimensions (e.g., shape, thickness, etc.) and/or material of the transpalatal region may be configured specifically to reduce, limit or prevent tipping and/or rotation of the molars and/or canines (or in some cases of the molars and/or anterior premolar teeth). The transpalatal region may extend between a first tooth engagement region (“first engagement region”) and a second tooth engagement region (“second tooth engagement region”). In general, the first and/or second tooth engagement regions may extend anteriorly further than the transpalatal region, which may reduce the reaction force between neighboring teeth and prevent tipping. For example the distalizers described herein may generally have an “h” or “H” shape, in which the anterior edge of the transpalatal region is posterior to the premolar and/or canine regions of the first and/or second engagement regions.

Any of these apparatuses may include a segmented design that decouples the A-P forces between the anterior and posterior segment of the subject's dental arch. The distalizers described herein may not include an anterior region engaging with the subject's incisors. Thus, the distalizers described herein may eliminate the need for an anterior bridge between the left and the right side of the arch, which may avoid aligner fracture during manufacturing and use. Alternatively, in some examples these distalizers may include a movably coupled anterior region that may engage with the subject's incisors when worn.

The distalizers described herein may include one or more hooks and/or buttons for attaching an elastic in order to apply or enhance a distalizing force. The elastic attachment (hook, button, etc.), in combination with the palatal region, can be configured to control distal tipping, reduce canine rotation, and redistribute distalization force for faster distalization. For example, the elastic attachment may be configured to be positioned on the canine and/or premolar regions of the distalizer so that, when worn, the elastic attachments are poisoned adjacent to the subject's canine and/or premolar teeth.

The distalizer apparatuses described herein may include a component configured to be worn on the maxillary teeth, including adjacent to the palatal region, as well as a component configured to be worn on the mandibular teeth; an elastic band (“elastic”) may be connected between the first component and the second component to apply or increase a distalizing force. The first component, configured to be worn on the maxillary teeth, may be referred to as simply the “distalizer” and the second component, configured to be worn on the mandibular teeth may be referred to as a mandibular distalizer. A distalizer apparatus or distalizer system may include both the first component and the second component, and both the first component and the second component may include an attachment for one or more elastic bands, as described herein.

For example, an orthodontic distalizer apparatus may include: a first tooth engagement region having one or more cavities shaped to accommodate one or more molar and one or more canine and/or premolar teeth, the first tooth engagement region comprising an outer buccal surface, an outer lingual surface and an outer occlusal surface; a second tooth engagement region having one or more cavities shaped to accommodate one or more teeth; a transpalatal region extending between the first tooth engagement region and the second tooth engagement region, the transpalatal region having an anterior edge that is posterior to a premolar region of the first tooth engagement region; and an attachment site for an elastic band on the outer buccal surface.

Any of these apparatuses may include a disoccluder on the outer occlusal surface configured to prevent or reduce intercuspation when the apparatus is worn. The disoccluder may comprise a bite ramp and/or bite block. For example, the disoccluder may comprise one or more of: an anterior bite ramp, a canine bite ramp and a posterior bite block.

The attachment site may be configured to be positioned proximate to a canine tooth when the apparatus is worn. In some examples the attachment site may be proximate to a premolar tooth. The attachment site comprises a button or hook. In some examples the attachment site is configured to be positioned over a gingival region when the apparatus is worn; for example, the attachment site may be configured to be more closely positioned relative to the center of mass (the center of resistance) of the canine or premolar tooth, which may reduce or prevent tipping and/or rotation. In some examples the attachment site is positioned at or near the trim line (e.g., within 5 mm, within 4 mm, within 3 mm, within 2 mm, within 1 mm, etc. of a trim line of the first tooth engagement region).

The one or more cavities of the second tooth engagement region may be shaped to accommodate one or more molar, premolar and canine teeth. In some examples the apparatus is configured as a unilateral distalizer having only one attachment site for the elastic band.

As mentioned, any of these apparatuses may include a lower jaw aligner apparatus configured to fit over the subject's mandibular teeth and comprising a complimentary elastic band attachment site.

In some examples the distalizer does not include an anterior segment region between the first and second tooth engagement regions. Any of the distalizers described herein may include an anterior segment region configured to couple between the first tooth engagement region and the second tooth engagement region and to engage with at least (or in some examples, just) the lingual surface of one or more incisor teeth. For example, the anterior segment region may be slidably coupled to the first and/or second tooth engagement regions.

The distalizers described herein may also or alternatively be configured to have different regions of different wall thickness that may help adjust the forces on the teeth to prevent or limit tipping and/or rotation (e.g., of the canine and/or premolar to which the attachment is coupled). For example, the anterior region of the first tooth engagement region and an anterior region of the second tooth engagement region may have a wall thickness that is greater than the wall thickness of a posterior region of the first tooth engagement region and the second tooth engagement region.

In any of these examples, the transpalatal region may not extend beyond an anterior premolar region of the first tooth engagement region and the second tooth engagement region.

For example, an orthodontic distalizer apparatus may include: a first tooth engagement region having one or more cavities shaped to accommodate one or more molar and one or more canine and/or premolar teeth, the first tooth engagement region comprising an outer buccal surface, an outer lingual surface and an outer occlusal surface that extends between the outer buccal surface and the outer lingual surface; a second tooth engagement region having one or more cavities shaped to accommodate one or more molar teeth; a transpalatal region extending between the first tooth engagement region the second tooth engagement region, the transpalatal region having an anterior edge that is posterior to a canine region and/or a premolar region of the first tooth engagement region, wherein the first tooth engagement region, the second tooth engagement region and the transpalatal region are formed of a continuous polymeric material; an attachment site for an elastic on the outer buccal surface configured to be positioned proximate to a canine tooth or premolar tooth when the apparatus is worn; and a disoccluder on the first tooth engagement region configured to prevent or reduce intercuspation when the apparatus is worn.

Also described herein are methods of using any of these apparatuses. For example, a method of distalizing a subject's teeth may include: applying distalizer apparatus to a subject's maxillary teeth so that the subject's teeth engage with a first tooth engagement region accommodating one or more molar and one or more canine and/or premolar teeth, a second tooth engagement region accommodating one or more teeth, and a transpalatal region extending between a molar region of the first tooth engagement region and a molar region of the second tooth engagement region; applying a lower jaw apparatus to the subject's lower jaw; coupling an elastic band to an attachment site on the distalizer apparatus and to an attachment site on the lower jaw apparatus to apply a distalizing force to the subject's molars, wherein transpalatal arch region applies a counter moment to the teeth to prevent or reduce lingual tipping of the subject's molars and/or canines. Any of these methods may also include preventing or reducing intercuspation using one or more disoccluders of the distalizer apparatus and/or the lower jaw apparatus.

Also described herein are methods of designing, making and/or manufacturing a distalizer apparatus as described herein. For example, a method of forming an orthodontic distalizer for a subject may include: generating, from a digital model of the subject's dentition, a digital model of a distalizer apparatus comprising a first tooth engagement region, a second tooth engagement region and a transpalatal region, wherein the first tooth engagement region is configured to accommodate a first set of the subject's maxillary teeth comprising one or more molars, a canine and/or one or more premolar teeth, wherein the second tooth engagement region is configured to accommodate a second set of the subject's maxillary teeth comprising a second one or more molars, and further wherein the transpalatal region is configured to extend between the first tooth engagement region and the second tooth engagement region adjacent to the subject's palate, and wherein generating the digital model of the distalizer apparatus further comprises: determining a position of an elastic band attachment site on the distalizer apparatus to apply a distalizing force to the subject's molars and/or premolars or canines when an elastic band is attached; and adjusting one or more dimensions of the transpalatal region so that the transpalatal region produces a counter force to prevent or limit crown tipping and rotation of molars and canines when the distalizer apparatus is worn; and transmitting the digital model of the orthodontic distalizer for fabrication.

Any of these methods may include receiving a digital model of the subject's current dentition including a palatal region of the subject's dentition, and/or receiving a digital model of the target arrangement (a final arrangement and/or one or more intermediate arrangements) of the patient's dentition. The methods described herein may include using the initial and/or final (or intermediate) positions of the dentition in order to design the distalizer and determine the forces (including distalizing forces and/or counter forces). As used herein, the term “subject” may refer to an appropriate subject, including a patient.

As mentioned, any of these apparatuses and methods may include the use of disoccluder (e.g., bite block, ramp, etc.) to prevent or limit intercuspation, which may enhance distalization. For example, generating the digital model of the distalizer apparatus may further comprise determining a position of a disoccluder on the distalizer apparatus to prevent or reduce intercuspation of the subject's upper and lower jaws when the distalizer apparatus is worn.

The transpalatal region may be configured to have an anterior edge that is posterior to a canine region and/or to a premolar region of the first tooth engagement region.

In general, determining the position of the elastic band attachment site may comprise calculating the distalizing force based the one or more dimensions of the transpalatal region (e.g., based a thickness and/or location of the transpalatal region). In some examples the distalizing force may be determined based on a target tooth position (e.g., a final or intermediate target tooth position).

In any of these methods and apparatuses, determining the position of the elastic band attachment site may include positioning the elastic band attachment site on a buccal extension of the first tooth engagement region configured to be over a gingival region. In some examples the method may include positioning the elastic band attachment site at or near a cut line of the distalizer (e.g., at the canine region and/or premolar region), including within about 5 mm, 4 mm, 3 mm, 2 mm, 1 mm, etc. of the cut line.

Any of these methods may include fabricating the orthodontic distalizer. The distalizer may be fabricated by 3D printing the orthodontic distalizer; in some example the distalizer may be fabricated by thermoforming.

For example, a method of forming an orthodontic distalizer for a subject may include: generating, from a digital model of the subject's dentition, a digital model of a distalizer apparatus comprising a first engagement region, a second engagement region and a transpalatal region, wherein the first engagement region is configured to accommodate a first set of the subject's maxillary teeth comprising one or more molars, a canine and/or one or more premolar teeth, wherein the second engagement region is configured to accommodate a second set of the subject's maxillary teeth comprising a second one or more molars, and further wherein the transpalatal region is configured to extend between the first engagement region and the second engagement region adjacent to the subject's palate; wherein generating the digital model of the distalizer apparatus further comprises: determining a position of an elastic band attachment site on the distalizer apparatus to apply a distalizing force to the subject's molars and/or premolars or canines when an elastic band is attached based at least in part on one or more dimensions of the transpalatal region; adjusting the one or more dimensions of the transpalatal region so that the transpalatal region produces a counter force to prevent or limit crown tipping and rotation of molars and canines when the distalizer apparatus is worn; and determining a position of a disoccluder on the distalizer apparatus to prevent or reduce intercuspation of the subject's upper and lower jaws when the distalizer apparatus is worn; and transmitting the digital model of the orthodontic distalizer for fabrication.

Also described herein are apparatuses (e.g., software, firmware and/or hardware) for performing any of these methods, including non-transitory computer-readable storage medium storing a set of instructions capable of being executed by a processor, that when executed by the processor causes the processor to perform any of these methods. For example, described herein are non-transitory computer-readable storage medium storing a set of instructions capable of being executed by a processor, that when executed by the processor causes the processor to perform a method of: generating, from a digital model of a subject's dentition, a digital model of a distalizer apparatus comprising a first engagement region, a second engagement region and a transpalatal region, wherein the first engagement region is configured to accommodate a first set of the subject's maxillary teeth comprising one or more molars, a canine and/or one or more premolar teeth, wherein the second engagement region is configured to accommodate a second set of the subject's maxillary teeth comprising a second one or more molars, and further wherein the transpalatal region is configured to extend between the first engagement region and the second engagement region adjacent to the subject's palate, and wherein generating the digital model of the distalizer apparatus further comprises: determining a position of an elastic band attachment site on the distalizer apparatus to apply a distalizing force to the subject's molars and/or premolars or canines when an elastic band is attached; and adjusting one or more dimensions of the transpalatal region so that the transpalatal region produces a counter force to prevent or limit crown tipping and rotation of molars and canines when the distalizer apparatus is worn; and transmitting the digital model of the distalizer apparatus for fabrication.

For example, a non-transitory computer-readable storage medium storing a set of instructions capable of being executed by a processor, that when executed by the processor causes the processor to perform a method of: generating, from a digital model of the subject's dentition, a digital model of a distalizer apparatus comprising a first engagement region, a second engagement region and a transpalatal region, wherein the first engagement region is configured to accommodate a first set of the subject's maxillary teeth comprising one or more molars, a canine and/or one or more premolar teeth, wherein the second engagement region is configured to accommodate a second set of the subject's maxillary teeth comprising a second one or more molars, and further wherein the transpalatal region is configured to extend between the first engagement region and the second engagement region adjacent to the subject's palate; wherein generating the digital model of the distalizer apparatus further comprises: determining a position of an elastic band attachment site on the distalizer apparatus to apply a distalizing force to the subject's molars and/or premolars or canines when an elastic band is attached based at least in part on one or more dimension of the transpalatal region; adjusting the one or more dimensions of the transpalatal region so that the transpalatal region produces a counter force to prevent or limit crown tipping and rotation of molars and canines when the distalizer apparatus is worn; and determining a position of a disoccluder on the distalizer apparatus to prevent or reduce intercuspation of the subject's upper and lower jaws when the distalizer apparatus is worn; and transmitting the digital model of the distalizer apparatus for fabrication.

In general, the methods and apparatuses (including distalizers) described herein may be configured to prevent pull-off of the apparatus while still applying distalizing forces. In particular, the apparatuses and method described herein may be configured to minimize or reduce the pulling off of the appliance (e.g., aligner, palatal expander, etc.) due to the distalizing force(s). The dental appliances described herein may include, for example, or more attachments and may be configured, using the software-related apparatuses and methods described herein, to enhance retaining of the appliance on the teeth while still applying significant distalizing force. For example, these apparatuses may include a transpalatal arch (TPA). The TPA may be integrated with distalizer and may control the lingual tipping of the molars, reduce reaction forces to neighboring teeth, and enable arch expansion at the same time. In some examples, these apparatuses may include a segmented design that decouples the A-P forces between the anterior and posterior segment of the arch. Any of these apparatuses may include hooks and buttons for elastic to control distal tipping, reduce canine rotation, and redistribute distalization force for faster distalization.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 schematically illustrates a class II malocclusion that may be treated by the methods and apparatuses described herein.

FIG. 2 shows one example of an apparatus for applying a distalizing force, shown on a model of an upper and lower jaw.

FIGS. 3A-3F illustrate the force system resulting on the teeth for an apparatus such as the example shown in FIG. 2.

FIG. 4 is an example of a distalizer including a transpalatal region as described herein.

FIG. 5 is an example of a distalizer including a transpalatal region as described herein.

FIG. 6 is an example of a bilateral distalizer.

FIG. 7 is an example of a unilateral distalizer.

FIG. 8 is an example of a bilateral distalizer shown worn on an upper jaw.

FIG. 9 is an example of a unilateral distalizer shown worn on a lower jaw.

FIGS. 10A-10F illustrate an example of the forces (force system) resulting from a bilateral distalizer such as the one shown in FIG. 8 with three different elastic bands applied (4 oz elastic band, solid, 6 oz elastic band, dashed, and 8 oz elastic band, dot-dashed).

FIGS. 11A-11C illustrate another example of a distalizer including an anterior region engaging with incisor teeth that is slidably coupled to the rest of the distalizer. FIG. 11A shows the apparatus worn on an upper jaw. FIG. 11B shows the anterior region. FIG. 11C shows the posterior region.

FIG. 12 schematically illustrates the use of an occluder that may be used in conjunction with a distalizer as described here.

FIG. 13 schematically illustrates occluders that may be used with any of the distalizer apparatuses described herein.

FIG. 14 shows one example of an attachment (e.g., configured as a hook) that may be used with any of the distalizer apparatuses described herein.

FIG. 15 illustrates an example of a region of a distalizer as described herein, including an attachment on a buccal extension of a first tooth engagement region configured to be over a gingival region.

FIG. 16 shows an example of a distalizer including a reinforced anterior region.

FIG. 17 is an example of a distalizer including an anterior region with a reinforced (thickened) region.

FIG. 18 schematically illustrates an example of a method of making a distalizer apparatus as described herein.

### DETAILED DESCRIPTION

Apparatuses and methods for molar distalization are described herein. Any of these distalizer apparatuses may be patient-removable appliances that include an upper (maxillary) device with two or more tooth separate but connected engagement regions each having one or more cavities shaped to accommodate teeth, typically one or more molar and one or more canine and/or premolar teeth, and an attachment site for coupling to an elastic band (e.g., rubber band) between the upper device and a lower (mandibular) device or attachment on the lower teeth. Any of these apparatuses may include a transpalatal region extending between the engagement regions. The devices may be configured with one or more features (including the transpalatal region, the regional thickness of the device, etc.) so that the distalizing force(s) applied are modulated to prevent or reducing tipping and/or rotation of the teeth, in particular the anterior tooth (e.g., canine or premolar) and/or the molar.

The distalizers described herein may be superior to other distalizing methods and apparatuses, which may result in undesirable tipping or rotation of the teeth or may take a long time and/or may be incompatible with treatment plants involving dental aligners. For example, the methods and apparatuses described herein may use a transpalatal arch (TPA) as part of the distalizer. The transpalatal arch may provide for both structural integrity and a better distribution of forces (referred to herein as a force system). In general, these distalizers may have a segmented design, including two or more engagement regions that are connected by a transpalatal arch. The engagement regions may extend more anteriorly than the transpalatal arch region. In general, the distalizer may cover the molars and premolars and in some examples the canine teeth on at least one side of the mouth, while the transpalatal region may extend only between the molars but may not extend any further anterior than the molars or the posterior premolar. In some examples these apparatuses do not extend to the incurs in the upper jaw.

Any of these apparatuses and methods may include a disoccluder, such as a bite ramp or bite block that may prevent intercuspation of between the upper and lower jaw, which may inhibit distalization.

Any of these apparatuses and methods may modify the attachment site (e.g., hook, button, etc.) to minimize rotational and/or tipping forces on the tooth over which the attachment site is applied (e.g., canine, premolar, etc.). In some examples it may be particularly beneficial to include a hook, which may reduce or limit tipping and/or rotation. In some examples the attachment may be a button attachment for an elastic (e.g., an elastic band). The attachment site may be positioned further towards or over the gingiva, in order to reduce tipping and/or rotational forces.

Any of these apparatuses and methods may be configured to have a greater stiffness in some regions (e.g., including a greater thickness) by increasing device thickness or introducing a support (e.g., lingual bar). In general, these apparatuses (upper device, lower devices, etc.) may be formed of a single material, such as a thermoformed sheet of material, and/or may be formed by a 3D printing technique

Thus, the apparatuses and methods described herein may avoid fracture or permanent deformation of the distalizer. These apparatuses may also reduce or eliminate (e.g., may minimize) the counter moment generated as a result of mesial-out rotation of molars when using transpalatal arch regions (e.g., for transpalatal expansion). In general, these methods and apparatuses may be used as part of a treatment plan, and/or as part of a treatment plan including arch expansion (palatal expansion). Although the application of distalizing and/or expansion forces is known to result in counter forces or moments that would otherwise have undesired lingual/buccal forces on the molars, the methods and apparatuses described herein are configured to distribute the reaction forces across to the other side of the jaw, and to reduce tooth lingual tipping (e.g., of molars and/or canines). For example, any of the apparatuses described herein may be configured so that the distalizer includes a transpalatal arch that is further configured to apply a counter force to push the teeth buccally to avoid the tipping moment from the elastics.

In general, these methods and apparatuses may be used to customize the force level and may help balance the distal component and the vertical component of the force from the applied distalizing force (e.g., from the elastic member). These methods and apparatuses may apply a sufficient amount of transverse force for the arch expansion in addition to preventing tipping and may be particularly helpful to create a space for de-crowding. Thus, these methods and apparatuses may suppress tooth distal crown tipping of molars and canines and reduce canine rotation.

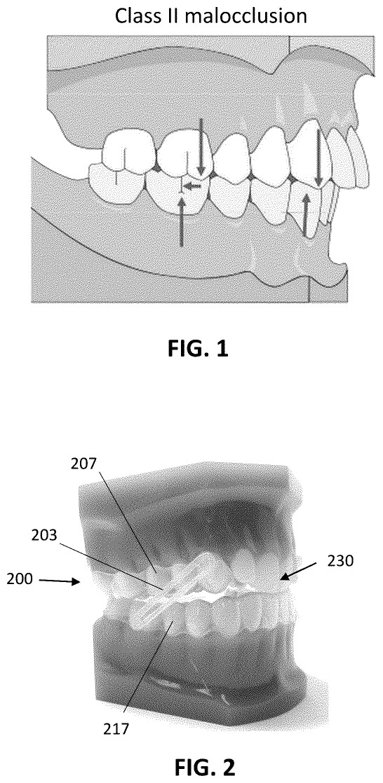

FIG. 1 illustrates an example of a class II malocclusion that may be treatment using the methods and apparatuses described herein. A malocclusion is generally a misalignment or incorrect relation between the teeth of the two dental arches when they approach each other as the jaws close. For example, in a class II malocclusion, such as shown in FIG. 1, the maxillary anterior teeth may be protruded and the mesiobuccal groove of the mandibular first molar may be distally (e.g., posteriorly) positioned when in occlusion with the mesiobuccal cusp of the maxillary first molar. The mesiobuccal cusp of maxillary first molar may rest in between the first mandibular molar and second premolar. Teeth may be proclined, and a large overjet may be present. In some examples the maxillary central incisors may be retroclined. The maxillary lateral incisor teeth may be proclined or normally inclined.

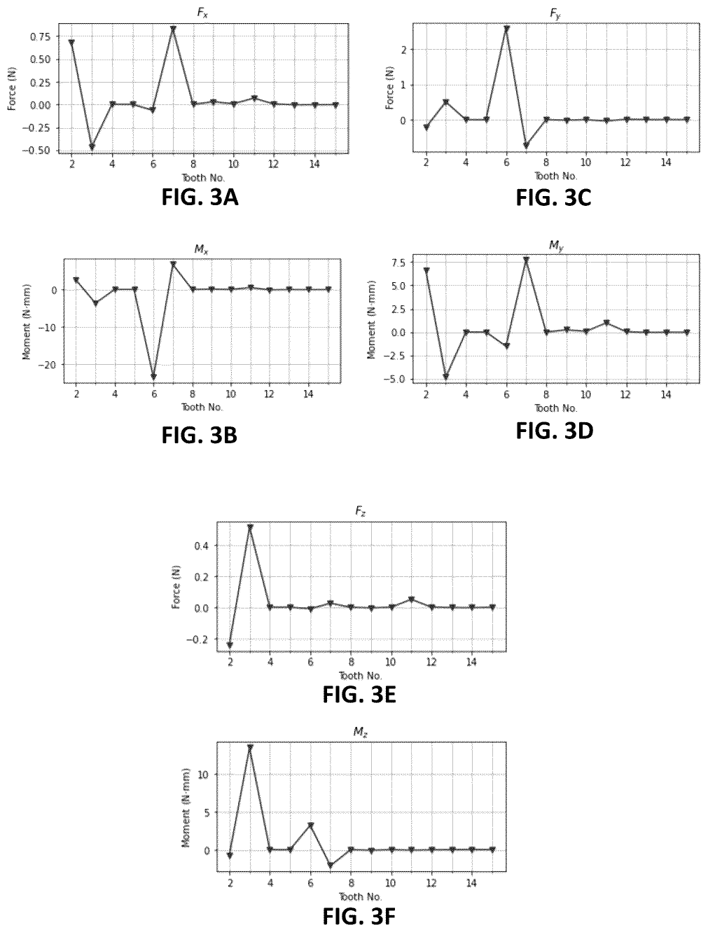

FIG. 2 shows an example of a distalizer 200 that include a pair of engagement regions 207 for the upper teeth (applied over the molars, premolars and canines). The upper devices couples to a lower device (aligner 217) on the lower teeth via a pair of attachment sites to which an elastic band 203 is applied. This example includes buccal-side cutouts for the incisors 230. The device may be subjected to bending, so the stress concentration may occur at the transition point between cutout and non-cutout region. The elastic 203 may apply a distalization force on a button attached on tooth or on a hook, e.g., formed by cutting the aligner at the canine. The resulting force in this example, may be close to the canine crown, and relatively far from the tooth resistance center, resulting in generating a moment that may induce distal crown tipping. The force system in this example, may result in lingual tipping for molars and canines. See, e.g., FIGS. 3A-3F, illustrating the forces acting on the teeth in x (FIG. 3A), y (FIG. 3C), z (FIG. 3E), and the resulting moments in x (FIG. 3B), y (FIG. 3D) and z (FIG. 3F).

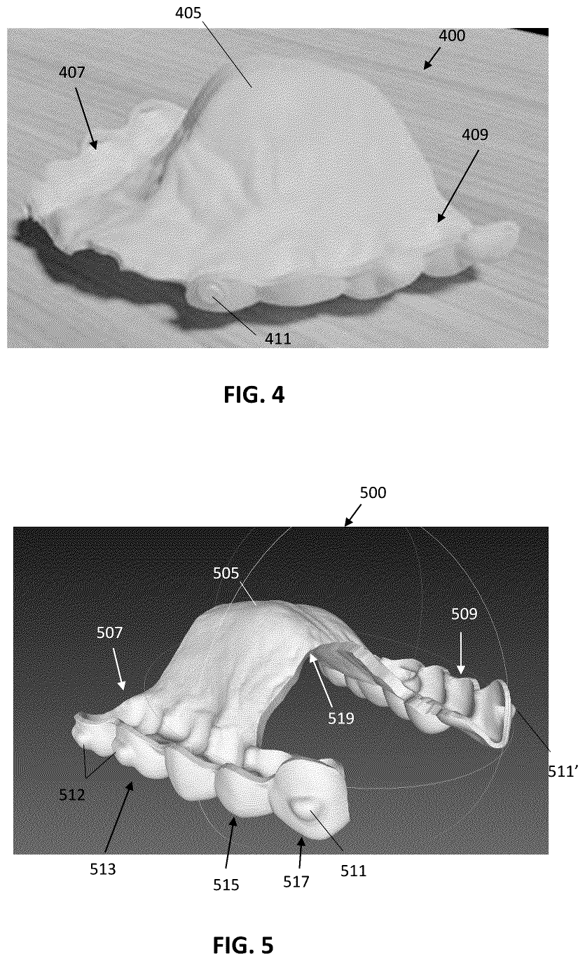

As mentioned, any of the distalizers described herein may include a transpalatal region. FIG. 4 illustrates an example of a transpalatal region 405 extending between a first tooth engagement region 409 having one or more cavities shaped to accommodate one or more molar and one or more canine and/or premolar teeth, and a second tooth engagement region 407 having one or more cavities shaped to accommodate one or more molar and one or more canine and/or premolar teeth. The tooth engagement regions each include an outer buccal surface, an outer lingual surface and an outer occlusal surface In FIG. 4 an attachment site (e.g., button) 411 for an elastic band is positioned on a buccal surface of the region of the first engagement region over the canine region of the first engagement region.

In general, the transpalatal structure can provide support and redistribute the force in facial and palatal directions. Such transpalatal structures can prevent the teeth from lingual crown tipping and constrain their mesial-out rotation when distalizing force is applied, e.g., by the elastic band. Additionally, the transpalatal region may improve the device integrity and strength, reducing or preventing the need for reinforcement by, e.g., an anterior lingual bar which may otherwise cause discomfort. In general, these distalizer apparatuses may be very comfortable while still strong, preventing device structural damage and reducing tongue irritation.

In FIG. 4 the transpalatal region extends up to the lingual surface of the incisors (anterior). However, it may be particularly beneficial to cut or limit the transpalatal region. In some examples the coverage and/or thickness of the transpalatal region of the distalizer can be adjusted. By removing the anterior portion of the transpalatal region, the buccal thrust force from the tongue can be further minimized.

For example, FIG. 5 illustrate an example of a bilateral distalizer including a transpalatal region 505 that extends anteriorly only up to the premolars. For example, in general, the transpalatal region may have an anterior edge 519 that extend only anterior to about the premolar region 515 of the tooth engagement regions 507, 509; e.g., the transpalatal region has an anterior edge 519 that is posterior to the premolar region 515 of each of the tooth engagement regions. In FIG. 5 the distalizer 500 (maxillary device) shown also includes a molar region 513 and canine region 517 in which the subject's molars and canine, respectively, may sit. The distalizer also includes a pair of attachments 511, 511′ to which an elastic band (not shown) may be attached. These attachments may be formed as hooks and/or buttons. In some examples the distalizer may also include coupling region 512 that may couple to attachments on the teeth to help secure the distalizer in place. Any of the distalizer devices described herein may also be configured to apply a translational force to a tooth to move the tooth in addition to the distalizing force and/or palatal expansion force.

In general, a distalizer with a transpalatal region can be manufactured in any appropriate manner, e.g., by thermoforming or 3D printing. For example, the methods described herein may include generating a digital plan for the distalizer which can be used to manufacture the distalizer. The distalizer may be configured as part of a treatment plan including moving of the teeth (aligning the teeth) and/or expanding the palate. As mentioned, any of the distalizers described herein may include a transpalatal region that can treat palatal expansion and distalization simultaneously.

As shown in FIG. 5, the transpalatal region 505 does not need to cover entire palatal surface. The apparatus 500 may include a longer trimline of aligner on the lingual side that can provide extra strength to generate facial or palatal force.

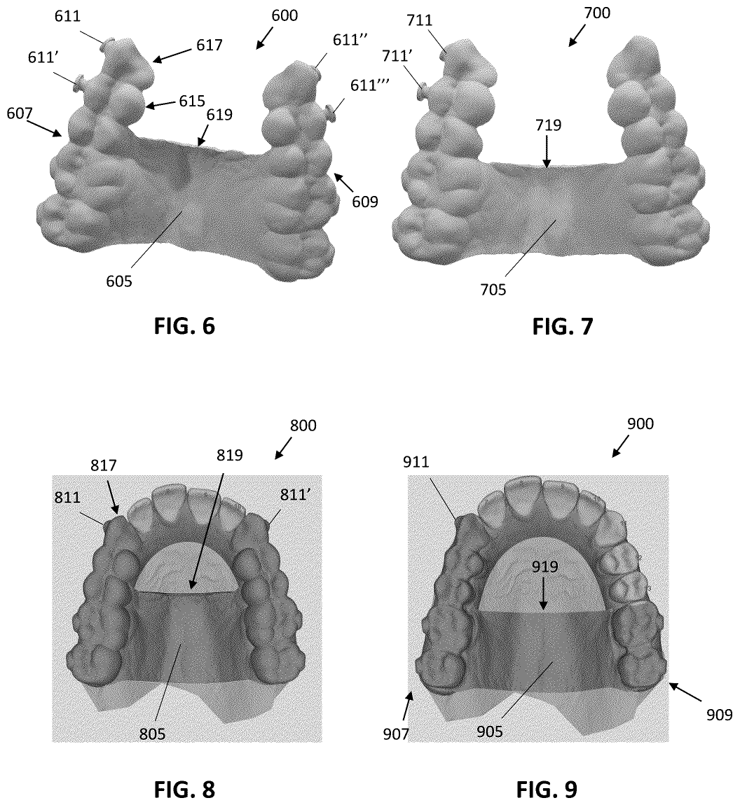

FIGS. 6-9 illustrate examples of distalizer apparatuses that including a transpalatal region that is posterior to the anterior regions of the first and/or second tooth engagement regions. FIG. 6 shows an example of a distalizer 600 that includes a transpalatal region 605 having an anterior edge 619 that is posterior to the premolar region 615 of the first and second tooth engagement regions 607, 609. The distalizer shown in FIG. 6 is configured as a bilateral distalizer and include an attachment site for an elastic band on both sides (the first tooth engagement region 607 and the second tooth engagement region 609). In the example shown in FIG. 6 each side includes a pair of attachment sites, one on the canine region 611, 611″ and one on the premolar region 611′, 611′″; this configuration may allow the subject to select where to apply the elastic or to apply multiple elastics.

FIG. 7 illustrates an example of a distalizer 700 that also includes a transpalatal region 705 having an anterior edge 719 that is posterior to the anterior ends of the first and second tooth engagement regions, similar to the device shown in FIG. 6. However, the distalizer shown in FIG. 7 is configured as a unilateral distalizer and includes attachment site(s) 711, 711′ on just the first tooth engagement region.

FIGS. 8 and 9 also illustrate bilateral and unilateral distalizers, respectively. The distalizers shown in FIGS. 8 and 9 include a transpalatal arch structure 805, 905, and do not cover or contact the incisors. In FIG. 8 the bilateral distalizers includes a premolar region that may be configured so as to include a gap or space within the tooth engagement region (a “bubble out” region). In general, any of the distalizers described herein may include such a bubble out region for the premolars and/or the anterior molar, which may allow movement of these teeth when wearing the distalizers.

In any of these distalizers the transpalatal regions may have limited coverage as shown and may be thicker than the tooth engagement regions (all or some of the tooth engagement regions). In FIG. 8 both sides (both tooth engagement regions) include an attachment site 811, 811′ for an elastic band.

The example shown in FIG. 9 includes both a first and second tooth engagement region, but the second tooth engagement region 909 is configured to cover just the molars, but not the premolar and canines, whereas the first tooth engagement region 907 is configured to engage with the molars, premolars and canine on the opposite side of the maxilla.

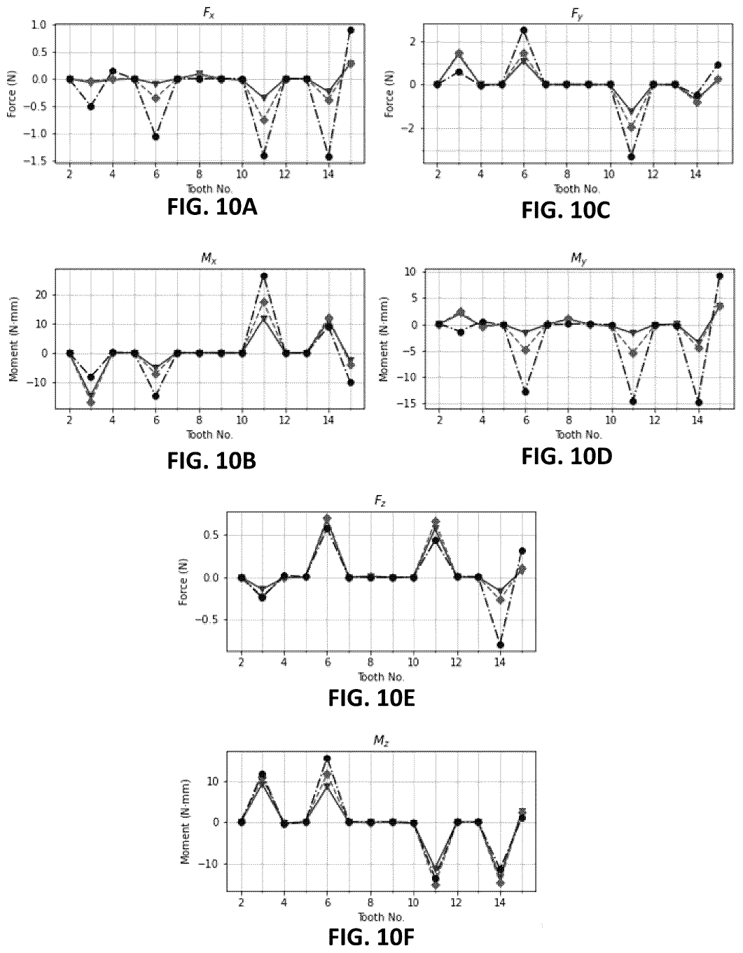

In general, these apparatuses may be configured to provide a force system that applies significant distalizing force to the appropriate teeth, while preventing tipping and/or rotation of the teeth, which may otherwise contribute towards further malocclusion. For example, FIGS. 10A-10F illustrate the force system of a bilateral distalizer similar to that shown in FIG. 8, showing the force applied in each of the x, y and z directions, as well as the moments Mₓ, M_{y}, and M_{z}. In this example, the resulting forces and moments are shown for each of these different elastic bands. The solid lines shown the forces for a 4 oz elastic band, the dashed lines show the forces for 6 oz elastic band, and the dot-dashed line show the forces for an 8 oz elastic band. FIG. 10A shows the forces in the x direction on each tooth (numbered by convention), FIG. 10C shows the forces in the y direction on each tooth and FIG. 10E shows the force acting in the z direction on each tooth. FIGS. 10B, 10D and 10F show the moments (Mₓ, M_{y}, and M_{z}, respectively) for each tooth in the upper jaw.

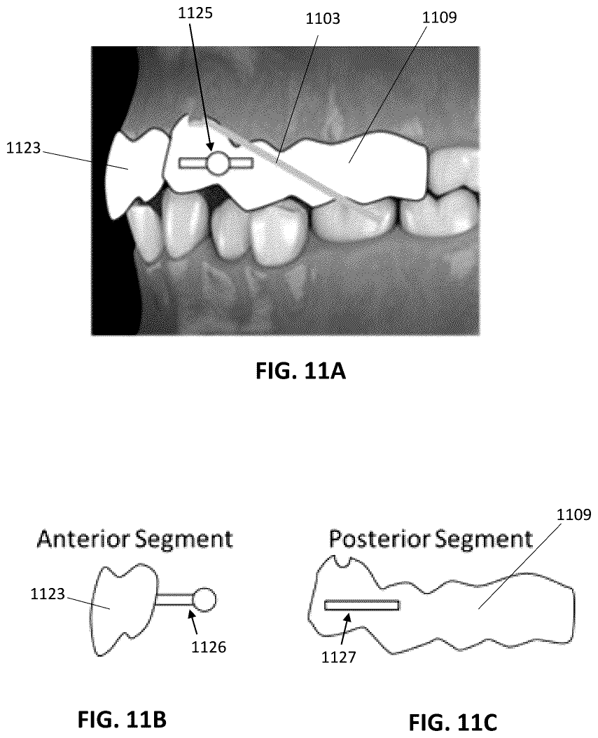

In any of these apparatuses and methods described herein, the distalizer may include an (optional) anterior segment that is connected to the posterior segments (e.g., the tooth engagement regions) such that the connection can decouple the forces between the anterior and the posterior segments. For example, any of these apparatuses may include an anterior segment to accommodate one or more incisors, that is movably connected to the first and second tooth engagement regions. FIG. 11A shows one example of an apparatus including an anterior segment 1123 that is slidably coupled 1125 to a posterior segment 1109 (e.g., a tooth engagement region). The apparatus also includes an attachment site coupling to an elastic band that is also coupled to the lower jaw or a second device (e.g., shell) worn on the lower jaw. FIG. 11B shows an isolate view of the anterior segment including the connector 1126 that engages with a slider channel 1127, as shown in FIG. 11C. Other connectors may be used, including filament or wire connectors, hinged connectors, etc. The apparatus shown in FIG. 11A includes a sliding constraint so that moments and the distal force won't be applied to the anterior segment, while an extrusion/intrusion force can still be applied. This example but be used to do rotation, de-crowding, and relative leveling compared with one-piece design.

Any of the apparatuses described herein may alternatively or additionally include one or more disoccluders that are configured to prevent or reduce intercuspation between the subject's upper and lower jaws. For example, the distalizer may include a disoccluder such as one or more of an anterior bite ramp, a canine bite ramp and a posterior bite block. The lower jaw component of the distalizer apparatus may also or alternatively include a disoccluder. In any of these examples the disoccluder may help avoid intercuspation, because intercuspation can slow down the distalization movement. Disoccluder features may be included as part of the distalizer appliance, either attached or integrally formed. When the disoccluder is a bite ramp, the bite ramp may also provide additional benefits, such as limiting tooth extrusive movement, and/or may provide counter tipping moments.

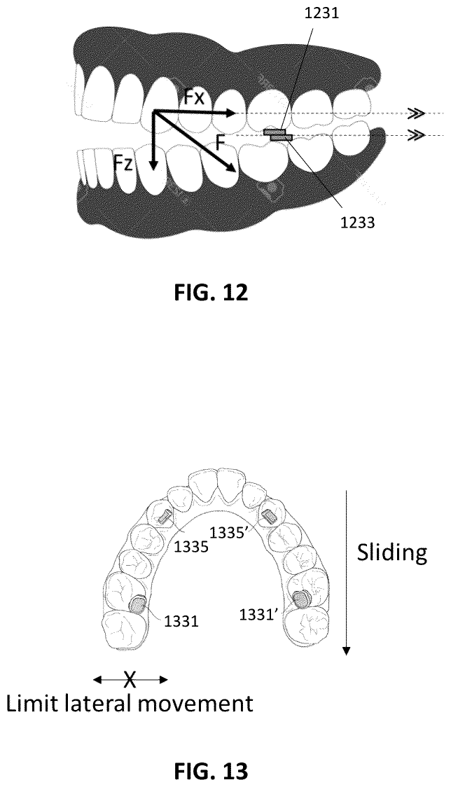

FIG. 12 schematically illustrates an example of a pair of disoccluders that may be included in any of these apparatuses. In FIG. 12 a first disoccluder 1231 is include on the upper jaw and a second disoccluder 1233 is included on the lower jaw. The disoccluder may engage with the teeth of the opposite jaw, an appliance worn on the teeth of the opposite jaw, or a second disoccluder on the appliance worn on the opposite jaw. In some examples the disoccluder is on the occlusal outer surface of the distalizer. Alternatively in some examples the disoccluder is on a lingual or buccal side. FIG. 13 schematically illustrates examples of disoccluders 1335, 1335′, 1331, 1331′ positioned on different location of an appliance such as a distalizer. The disoccluders shown may be ramps (e.g., bite ramps) and may help induce a force as descried herein (e.g., to prevent or limit rotation and/or tipping) in addition to limiting or preventing intercuspation.

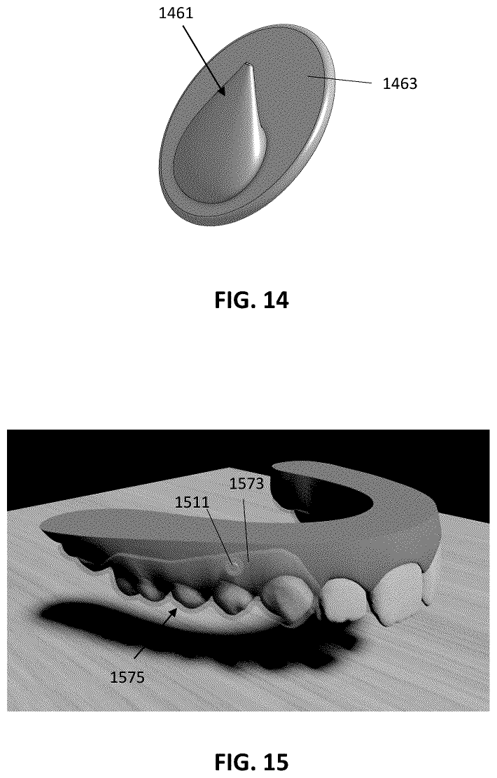

Any of the distalizer apparatuses described herein may include one or more attachment sites (e.g., connectors, buttons, hooks, etc.) forming or coupled the outer, buccal, side of the upper device (e.g., disoccluder) and a lower device. In some examples it may be beneficial to include an attachment site that is integrally formed (e.g., out of the same plastic or other polymeric material) with the rest of the disoccluder. For example, FIG. 14 shows an example of an attachment 1463 that includes a hook portion 1461 extending from a base. The base of the attachment 1511 may be affixed to the outer (e.g., buccal) surface of the distalizer, as shown in FIG. 15. In some examples it may be beneficial for the attachment site to be closer to the center of gravity of the tooth over which the distalizer 1575 is worn. For example, in FIG. 15 the attachment is shown coupled to (or integrally formed with) an extension region 1573 that extends over the gingiva of the canine region. For example, the attachment shown in FIG. 14 may be configured to reduce distal tipping; the attachment (e.g., hook) can be fabricated on the extension on buccal side as shown in FIG. 15, so the distalization force from elastic can be applied closer to the center of resistance. The extension can be formed by introducing an extension bar or a longer trimline. The hook geometry can be strengthened and optimized to avoid folding and fracture during daily uses. In some examples the hook can be made of TPU and integrated to the aligner by laser welding if manufactured by thermoforming. If manufactured by 3D printing, the hook can be printed together with the aligner.

The location and the orientation of the hook can be dynamically adjusted throughout the treatment, based on the location of the lower molar (where the elastic will be bonded) and the treatment goal. For example, if more vertical forces will be needed to level the arch, the button may be placed more distally to provide the needed extrusion forces. The attachment (e.g., hook) geometry can have other variations, as long as it can hold one end of an elastic band. Other geometries that may function similarly include button, groove, protrusion, etc.

Although many of the examples described herein do not include an anterior segment or region (e.g., engaging with the subject's incisors) or include a separately movable anterior segment, in some examples these apparatuses include a fixed anterior segment on the distalizer that may be reinforced or structured to prevent or limit fragility and/or breakage of this region or the connection between the two sections.

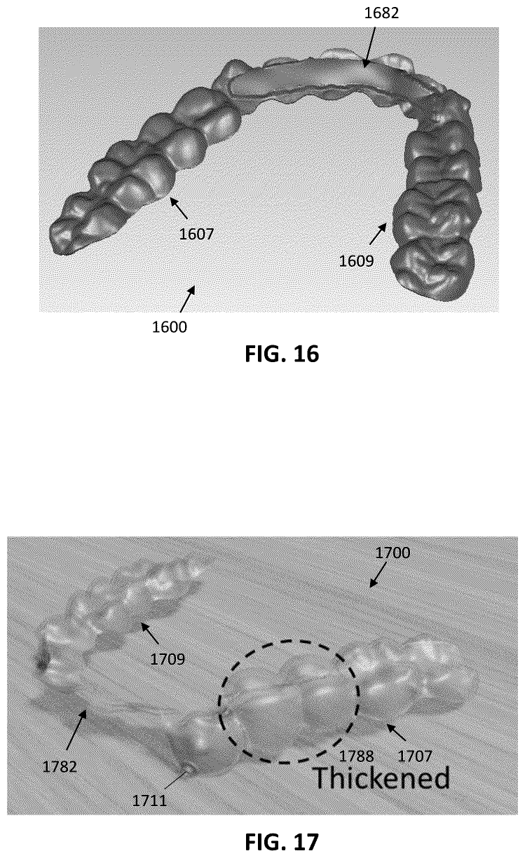

For example in FIG. 16, the apparatus 1600 is a distalizer apparatus with a first tooth engagement region 1607 and a second tooth engagement region 1609 that is rigidly connected to an anterior region 1682. Thus, in some examples the Distalizer may include a cut-out of the buccal and occlusal side of incisors as a connector. Such connector may suffer from fracture during the manufacturing or even daily uses. Locally thickening the materials when manufactured by 3D printing or adding lingual bar when manufactured by thermoforming can help reduce the possibility of material failure. Creating a flat geometry on the lingual surface of the anterior teeth allows welding of a strengthening lingual bar to the surface of the thermoformed aligner.

FIG. 17 illustrates another example of a distalizer 1700 including a first (e.g., left) and second (e.g., right) tooth engagement region that are both coupled in an anterior section. The portion of the first and second tooth engagement regions 1707, 1709 adjacent to the anterior region 1782 (e.g., in the premolar region (which may be bubbled out) may be thickened 1788 or otherwise strengthened. The device shown in FIG. 17 also includes an attachment site 1711 on an outer buccal surface of the canine region. In some cases, to improve distalization force on teeth, the apparatus may be strengthened with lingual bar or by thickening the material between canine and molar, as shown in FIG. 17, which may help redistribute the force.

### Methods of Making Distalizers

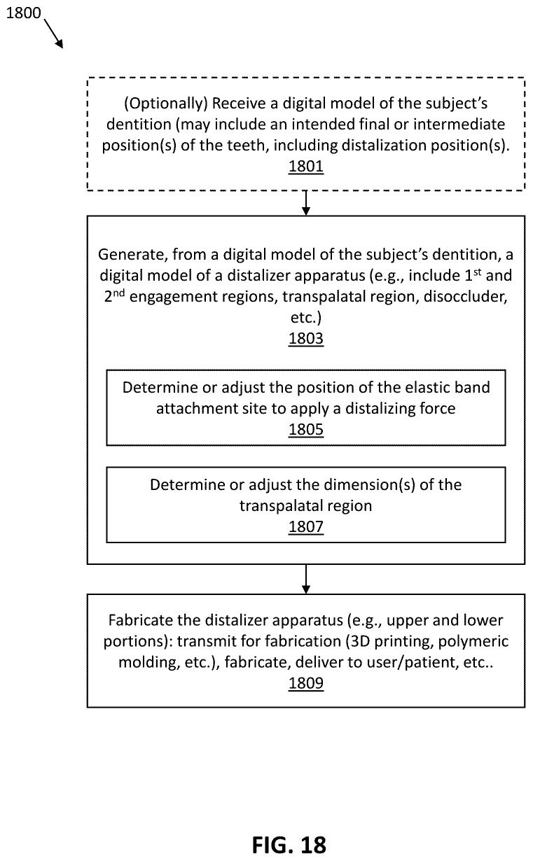

Also described herein are methods of making (e.g., designing, fabricating, etc.) and methods of using any of these distalizers. For example, FIG. 18 illustrates one method 1800 of making a distalizer. In this example, which may include a computer performed portion (and may therefore be embodied as a software, such as a non-transitory computer-readable storage medium storing a set of instructions capable of performing the method) may begin by, optionally, receiving, in a processor, a digital model of the subject's dentition, including the subject's upper and lower jaw, and the palatal region 1801. The digital model may be taken by a scanner (e.g., an intraoral scanner) of may be generated as a digital model.

The method may then include forming an orthodontic distalizer for a subject by generating, from the digital model of the subject's dentition, a digital model of a distalizer apparatus 1803 comprising a first tooth engagement region, a second tooth engagement region and a transpalatal region, etc. The first tooth engagement region may be configured to accommodate a first set of the subject's maxillary teeth comprising one or more molars, a canine and/or one or more premolar teeth, wherein the second tooth engagement region is configured to accommodate a second set of the subject's maxillary teeth comprising a second one or more molars, and further wherein the transpalatal region may be configured to extend between the first tooth engagement region and the second tooth engagement region adjacent to the subject's palate. Generating the digital model of the distalizer apparatus may comprise: determining a position of an elastic band attachment site on the distalizer apparatus to apply a distalizing force 1805 to the subject's molars and/or premolars or canines when an elastic band is attached. The distalizing force may be estimated or calculated from the position of the attachments, the elastic band characteristic(s), etc. The distalizing force may be set to a target distalizing force base on user (e.g. dentist, orthodontist, technician, etc.) input, including a targeted tooth arrangement and/or treatment plan. The distalizing force may be predetermined and/or modified by the user.

The step of generating the digital model of the distalizer may also include determining and/or adjusting one or more dimensions of the transpalatal region 1807 so that the transpalatal region produces a counter force to prevent or limit crown tipping and rotation of molars and canines when the distalizer apparatus is worn. This step may include estimating or calculating the counter force based on the current and/or target tooth position, the morphology of the subject's upper and/or lower jaw and the proposed position(s) of the attachment sites and characteristic(s) of the distalizer. The step of generating the digital model of the distalizer apparatus may include generating digital models of one or both of the upper arch device (‘distalizer device’) and/or the lower arch device. The step of generating the distalizer apparatus may be iteratively performed. Finally, once the digital model of the distalizer is generated, it may be optionally modified and/or transmitted for further processing (not shown). The method may include fabricating the document before 1809. For example, transmitting the digital model of the orthodontic distalizer for fabrication, such as fabricating, e.g., by 3D printing, etc.) 1809.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An orthodontic distalizer apparatus, comprising:
a first tooth engagement region having one or more cavities shaped to accommodate one or more molar and one or more canine and/or premolar teeth, the first tooth engagement region comprising an outer buccal surface, an outer lingual surface and an outer occlusal surface;
a second tooth engagement region having one or more cavities shaped to accommodate one or more teeth;
a transpalatal region extending between the first tooth engagement region and the second tooth engagement region, the transpalatal region having an anterior edge that is posterior to a premolar region of the first tooth engagement region; and
an attachment site for an elastic band on the outer buccal surface.

2. The apparatus of claim 1, further comprising a disoccluder on the outer occlusal surface configured to prevent or reduce intercuspation when the apparatus is worn.

3. The apparatus of claim 2, wherein the disoccluder comprises a bite ramp or bite block.

4. The apparatus of claim 2, wherein the disoccluder comprises one or more of: an anterior bite ramp, a canine bite ramp and a posterior bite block.

5. The apparatus of claim 1, wherein the attachment site is configured to be positioned proximate to a canine tooth when the apparatus is worn.

6. The apparatus of claim 1, wherein the attachment site comprises a button or hook.

7. The apparatus of claim 1, wherein the attachment site is configured to be positioned over a gingival region when the apparatus is worn.

8. The apparatus of claim 1, further wherein the attachment site is positioned within 5 mm of a trim line of the first tooth engagement region.

9. The apparatus of claim 1, wherein the one or more cavities of the second tooth engagement region is shaped to accommodate one or more molar, premolar and canine teeth.

10. The apparatus of claim 1, wherein the apparatus is configured as a unilateral distalizer having only one attachment site for the elastic band.

11. The apparatus of claim 1, further comprising a lower jaw aligner apparatus configured to fit over the subject's mandibular teeth and comprising a complimentary elastic band attachment site.

12. The apparatus of claim 1, further comprising an anterior segment region configured to couple between the first tooth engagement region and the second tooth engagement region and to engage with a lingual surface of one or more incisor teeth.

13. The apparatus of claim 12, wherein the anterior segment region is slidably coupled to the first and/or second tooth engagement regions.

14. The apparatus of claim 1, wherein an anterior region of the first tooth engagement region and an anterior region of the second tooth engagement region have a wall thickness that is greater than the wall thickness of a posterior region of the first tooth engagement region and the second tooth engagement region.

15. The apparatus of claim 1, wherein the transpalatal region does not extend beyond an anterior premolar region of the first tooth engagement region and the second tooth engagement region.

16. An orthodontic distalizer apparatus, comprising:
a first tooth engagement region having one or more cavities shaped to accommodate one or more molar and one or more canine and/or premolar teeth, the first tooth engagement region comprising an outer buccal surface, an outer lingual surface and an outer occlusal surface that extends between the outer buccal surface and the outer lingual surface;
a second tooth engagement region having one or more cavities shaped to accommodate one or more molar teeth;
a transpalatal region extending between the first tooth engagement region the second tooth engagement region, the transpalatal region having an anterior edge that is posterior to a canine region and/or a premolar region of the first tooth engagement region, wherein the first tooth engagement region, the second tooth engagement region and the transpalatal region are formed of a continuous polymeric material;
an attachment site for an elastic on the outer buccal surface configured to be positioned proximate to a canine tooth or premolar tooth when the apparatus is worn; and
a disoccluder on the first tooth engagement region configured to prevent or reduce intercuspation when the apparatus is worn.

17.-18. (canceled)

19. A method of forming an orthodontic distalizer for a subject, the method comprising:
generating, from a digital model of the subject's dentition, a digital model of a distalizer apparatus comprising a first tooth engagement region, a second tooth engagement region and a transpalatal region, wherein the first tooth engagement region is configured to accommodate a first set of the subject's maxillary teeth comprising one or more molars, a canine and/or one or more premolar teeth, wherein the second tooth engagement region is configured to accommodate a second set of the subject's maxillary teeth comprising a second one or more molars, and further wherein the transpalatal region is configured to extend between the first tooth engagement region and the second tooth engagement region adjacent to the subject's palate, and wherein generating the digital model of the distalizer apparatus further comprises:
determining a position of an elastic band attachment site on the distalizer apparatus to apply a distalizing force to the subject's molars and/or premolars or canines when an elastic band is attached; and
adjusting one or more dimensions of the transpalatal region so that the transpalatal region produces a counter force to prevent or limit crown tipping and rotation of molars and canines when the distalizer apparatus is worn; and
transmitting the digital model of the orthodontic distalizer for fabrication.

20. The method of claim 19, further comprising receiving a digital model of the subject's current dentition including a palatal region of the subject's dentition.

21. The method of claim 19, wherein generating the digital model of the distalizer apparatus further comprises determining a position of a disoccluder on the distalizer apparatus to prevent or reduce intercuspation of the subject's upper and lower jaws when the distalizer apparatus is worn.

22. The method of claim 19, wherein the transpalatal region is configured to have an anterior edge that is posterior to a canine region and/or to a premolar region of the first tooth engagement region.

23. The method of claim 19, wherein determining the position of the elastic band attachment site comprises calculating the distalizing force based the one or more dimensions of the transpalatal region.

24. The method of claim 23, wherein determining the position of the elastic band attachment site comprises calculating the distalizing force based a thickness and/or location of the transpalatal region.

25. The method of claim 19, wherein the distalizing force is determined based on a target tooth position.

26. The method of claim 19, wherein determining the position of the elastic band attachment site comprises positioning the elastic band attachment site on a buccal extension of the first tooth engagement region configured to be over a gingival region.

27. The method of claim 19, further comprising fabricating the orthodontic distalizer.

28. The method of claim 27, wherein fabricating the orthodontic distalizer comprises 3D printing the orthodontic distalizer.

29.-40. (canceled)
